(19) United States
(12) Patent Application Publication
(10) Pub. No.: US 2022/0328854 A1
(43) Pub. Date: Oct. 13, 2022

(54) FUEL CELL SYSTEM AND CONTROL METHOD FOR THE SAME

(71) Applicant: DOOSAN MOBILITY INNOVATION INC., Yongin (KR)

(72) Inventors: Hyeong Geun LEE, Busan (KR); Ho Keun Won, Hwaseong (KR); Kil Ho Bum, Asan (KR); Chang Seon Lee, Suwon (KR); Ji Sung Seo, Daejeon (KR)

(21) Appl. No.: 17/717,042

(22) Filed: Apr. 9, 2022

(30) Foreign Application Priority Data
Apr. 9, 2021 (KR) 10-2021-0046628

(51) Int. Cl. H01M 8/04828; H01M 8/24

(52) U.S. Cl. CPC H01M 8/04835; H01M 8/24

(57) ABSTRACT

The present invention relates to a fuel cell system and a control method for the same, it may be configured to include a plurality of stacks connected in series with each other, and supply moisture from one or more stacks of the plurality of stacks to one or more other stacks according to an operation condition of each of the plurality of stacks, and it has an advantage of improving an operation performance by uniformly forming the humidity condition of each of the plurality of stacks.

### CROSS REFERENCE TO RELATED APPLICATION

The present application claims priority to Korean Patent Application No. 10-2021-0046628, filed Apr. 9, 2021, the entire contents of which is incorporated herein for all purposes by this reference.

### BACKGROUND OF THE INVENTION

### Field of the Invention

The present invention relates to a fuel cell system and control method for the same, and more particularly, to a fuel cell system and control method for the same which can improve operation performance by supplying moisture from one or more stacks of a plurality of stacks to one or more other stacks according to an operation condition of each of the plurality of stacks to uniformly form a humidity condition for each of the plurality of stacks.

### Description of the Related Art

As a high-efficiency clean energy source, a fuel cell is gradually expanding its use area. Among various types of fuel cells, in particular, a polymer electrolyte membrane fuel cell (PEMFC) is superior to other types of fuel cells because it operates at a relatively low temperature, has a short start-up time, and has fast response characteristics to load changes.

Further, the polymer electrolyte membrane fuel cell has high efficiency and high current density and power density. Still further, it is less sensitive to changes in the pressure of reactive gases (hydrogen and oxygen in air) and can produce a wide range of outputs. For this reason, it can be applied to various fields such as a power source for pollution-free vehicles, self-generation, mobile and military power sources.

The polymer electrolyte membrane fuel cell is a device that generates electricity by electrochemically reacting hydrogen and oxygen to generate water. The supplied hydrogen is separated into hydrogen ions and electrons in the catalyst of an anode, and the separated hydrogen ions go to a cathode through an electrolyte membrane. At this time, the oxygen in the air supplied to the cathode is combined with the electrons that have entered the cathode through an external conductor to generate water, so that electrical energy is generated.

In order to obtain a potential required in an actual vehicle or drone, unit cells should be stacked as many as necessary potentials, and this stacking of unit cells is called a stack (or fuel cell stack). The potential generated by one unit cell is about 1.2V, and the power required for a load is supplied by stacking a number of cells in series. Each unit cell includes a membrane electrode assembly (MEA), and in the membrane electrode assembly, an anode electrode to which hydrogen is supplied and a cathode electrode to which air (oxygen) is supplied are provided on both sides with a polymer electrolyte membrane through which hydrogen ions are transmitted. In addition, a gas diffusion layer is disposed on the outsides of the anode electrode and the cathode electrode including catalyst layers, and a fuel cell stack is formed by sequentially stacking the membrane electrode assembly and a separator having reactant and coolant flow paths.

On the other hand, when a fuel cell produces energy, electricity is generated by an electrical reaction between hydrogen and oxygen. At this time, since it is an exothermic reaction, the temperature of the stack rises.

For the normal operation and stable output of a fuel cell, thermal management is essential. The cooling method of such a fuel cell stack includes an air cooling type and a water cooling type. In the case of air cooling type, natural cooling is performed using air flowing into the cathode electrode. In the case of water cooling type, a separate water circulating device is mounted on the fuel cell and cooling is performed with cooling water.

Since the water cooling type uses high-mass cooling water, it has better cooling capacity compared to the air-cooling type using low-mass air, but it requires a separate device, so it may be suitable for electric vehicles, etc. but is not suitable for flying objects such as drones that are sensitive to weight.

Since an air-cooled fuel cell system has a simple structure and can be operated with a minimum balance of plant (BOP), it is possible to build a lightweight system through this. Accordingly, an air-cooled fuel cell system is usually used for flying vehicles such as drones.

However, in the case of an air-cooled fuel cell system, it is difficult to specify the operation environment of the stack due to its simple structure, and in particular, there is a limitation in being vulnerable to humidification, which is a key element of the stack.

If the stack is not humidified properly and the humidity inside the stack is lowered, it may cause a problem of degradation of the stack performance.

Meanwhile, in the field of small fuel cells, a dead end mode operation method of closing an outlet through which hydrogen fuel is discharged is widely applied in order to increase the fuel utilization rate of hydrogen fuel.

However, there is a problem in that the performance of the stack is degraded due to the accumulation of impurities such as water vapor or nitrogen. As a result, the hydrogen fuel has no choice but to be discharged (ventilated) to the outside, which lowers the fuel utilization rate.

### SUMMARY OF THE INVENTION

The present invention has been devised to solve the problems of the related art as described above, and an object of the present invention is to provide a fuel cell system and a control method for the same capable of improving an operation performance by supplying moisture from one or more stacks of a plurality of stacks to one or more other stacks according to an operation condition of each of the plurality of stacks to uniformly form a humidity condition for each of the plurality of stacks.

The present invention for achieve the above objects relates to a fuel cell system, and the fuel cell system includes a plurality of stacks connected in series with each other, and may be configured to supply moisture from one or more stacks of the plurality of stacks to one or more other stacks according to an operation condition of each of the plurality of stacks.

In addition, in an embodiment of the present invention, the moisture may be supplied from one or more stacks having a relatively superior humidity condition of the plurality of stacks to one or more stacks having a relatively inferior humidity condition to uniformly form a humidity condition between the plurality of stacks.

In addition, in an embodiment of the present invention, by controlling a flow direction of air flowing into the plurality of stacks according to the humidity condition of the plurality of stacks, water vapor may be supplied from the one or more stacks having a relatively superior humidity condition of the plurality of stacks to the one or more stacks having a relatively inferior humidity condition.

In addition, in an embodiment of the present invention, by controlling a flow direction of hydrogen flowing into the plurality of stacks according to the humidity condition of the plurality of stacks, water vapor is supplied from the one or more stacks having a relatively superior humidity condition of the plurality of stack to the one or more stacks having a relatively inferior humidity condition.

In addition, in an embodiment of the present invention, when the moisture is supplied from the one or more stacks of the plurality of stacks to the one or more other stacks by controlling a flow direction of air flowing into the plurality of stacks, water vapor is supplied from the one or more other stacks of the plurality of stacks to the one or more stacks by controlling a flow direction of hydrogen flowing into the plurality of stacks so that the humidity condition of each of the plurality of stacks is uniformly formed.

In addition, in an embodiment of the present invention, a fuel cell system of the present invention may include a fuel tank which stores hydrogen fuel; a first stack in which a plurality of cells each having an anode and a cathode is stacked; a second stack in which the plurality of cells each having the anode and the cathode is stacked and which is disposed adjacent to the first stack; a duct which is formed to sequentially supply air to the first stack and the second stack; a blower which supplies the air to the first and second stacks through the duct; a first water trap in which liquid water or water vapor is stored; a first fuel pipe which connects the fuel tank and the anode of the first stack; and a first connection fuel pipe which connects the anode of the first stack and the anode of the second stack through the first water trap.

In addition, in an embodiment of the present invention, the duct may be configured to seal the first stack and the second stack so that the air supplied by the blower does not leak to an outside of the first stack and the second stack.

In addition, in an embodiment of the present invention, the fuel cell system may further include a second fuel pipe which connects the fuel tank and the anode of the second stack; a second water trap in which the water or the water vapor is stored; and a second connection fuel pipe which connects the anode of the second stack and the anode of the first stack through the second water trap.

In addition, in an embodiment of the present invention, the fuel cell system may further include a first valve which is installed in the first fuel pipe; a second valve which is installed in the second fuel pipe; and a control unit which controls at least one of the first valve, the second valve and the blower to enable a forward direction operation from the first stack to the second stack and a reverse direction operation from the second stack to the first stack according to operation states of the first stack and the second stack.

In addition, in an embodiment of the present invention, the fuel cell system may further include the control unit which controls the first valve and the second valve so that the hydrogen fuel is supplied to the anode of the first stack through the second water trap when humidification is required due to low humidity of the first stack or when performance degradation of the first stack occurs.

In addition, in an embodiment of the present invention, when the humidification is required due to the low humidity of the first stack, or when the performance degradation of the first stack occurs, the control unit may control the blower to supply an external air to the cathode of the first stack after passing through the cathode of the second stack.

In addition, in an embodiment of the present invention, the fuel cell system may further include a second fuel pipe which connects the fuel tank and the anode of the second stack; and a control unit which controls a first valve and the blower to supply the hydrogen fuel and the air to the second stack after passing through the first stack when humidification is required due to low humidity of the second stack or when performance degradation of the second stack occurs.

In addition, in an embodiment of the present invention, the fuel cell system may further include a first valve which is installed in the first fuel pipe; a second fuel pipe which connects the fuel tank and the anode of the second stack; a second valve which is installed in the second fuel pipe; and a control unit which controls at least one of the first valve, the second valve and the blower to enable a forward direction operation from the first stack to the second stack and a reverse direction operation from the second stack to the first stack according to operating states of the first stack and the second stack.

In addition, in an embodiment of the present invention, the fuel cell system may further include a third stack which is disposed between the first stack and the second stack, the duct may be configured to seal the first to third stacks.

In addition, in an embodiment of the present invention, the fuel cell system may further include a first valve which is installed in the first fuel pipe; a second fuel pipe which connects the fuel tank and the anode of the second stack; a second valve which is installed in the second fuel pipe; and a control unit which controls at least one of the first valve, the second valve and the blower so that a flow of the hydrogen fuel and a flow of the air supplied to the first stack and the second stack are in opposite directions or in the same direction according to operation states of the first stack and the second stack.

A method for controlling a fuel cell system of the present invention may include the steps of supplying air and hydrogen fuel to a first stack in which a plurality of cells each having an anode and a cathode is stacked; supplying the air passing through the first stack and unreacted hydrogen fuel not used in the first stack to a second stack in which the plurality of cells is stacked; and switching a supply direction of the air and the hydrogen fuel in a direction from the second stack to the first stack when performance degradation of the first stack occurs.

In addition, in an embodiment of the present invention, the method may include the step of switching a supply direction of the air and the hydrogen fuel in a direction from the second stack to the first stack includes the steps of supplying the air to the cathode of the first stack through a cathode of the second stack; supplying the hydrogen fuel of a fuel tank to an anode of the second stack; and supplying the unreacted hydrogen fuel of the second stack to the anode of the first stack.

In addition, in an embodiment of the present invention, the step of supplying the unreacted hydrogen fuel of the second stack to the anode of the first stack may include the step of supplying the unreacted hydrogen fuel to the anode of the first stack through a water trap in which liquid water or water vapor is stored.

In a method for controlling a fuel cell system of the present invention, the fuel cell system includes a plurality of cells, and the method may include the steps of supplying hydrogen fuel and air to the plurality of stacks so that supply directions of the hydrogen fuel and the air to the plurality of stacks are opposite to each other; and supplying the hydrogen fuel and the air to the plurality of stacks in the same direction so that a specific stack is positioned at a rear end of the flows of the hydrogen fuel and the air when performance degradation of the specific stack of the plurality of stacks occurs.

According to the present invention, a plurality of stacks arranged in series is operated in forward/reverse directions according to the humidity state of each stack to maintain the internal moisture balance of each stack of the plurality of stacks, so that the performance of each stack can be improved and optimized.

In addition, by switching the flow of hydrogen fuel or air fuel in the forward/reverse direction, it is possible to prevent impurities from being deposited in the inside of the stack in advance, thereby minimizing ventilation. As a result, it is possible to reduce wasted hydrogen, thereby maximizing fuel utilization rate.

### BRIEF DESCRIPTION OF THE DRAWINGS

FIG. 1 is a diagram showing the configuration and air control flow of a fuel cell system in a first embodiment according to the present invention.

FIG. 2 is a diagram showing a control flow of hydrogen fuel and moisture in the fuel cell system shown in FIG. 1.

FIG. 3 is a diagram showing another form of a control flow of hydrogen fuel and moisture in the fuel cell system shown in FIG. 1.

FIG. 4 is a diagram showing the configuration and air control flow of a fuel cell system in a second embodiment according to the present invention.

FIG. 5 is a diagram showing a control flow of hydrogen fuel and moisture in the fuel cell system shown in FIG. 4.

FIG. 6 is a diagram showing another form of a control flow of hydrogen fuel and moisture in the fuel cell system shown in FIG. 4.

FIG. 7 is a block diagram according to a first embodiment of a method for controlling a fuel cell system according to the present invention.

FIG. 8 is a block diagram according to a second embodiment of a method for controlling a fuel cell system according to the present invention.

### DETAILED DESCRIPTION OF THE INVENTION

Hereinafter, preferred embodiments of a fuel cell system and a control method thereof according to the present invention will be described in detail with reference to the accompanying drawings. A plurality of embodiments to be described below may be repeatedly applied to the configuration and method of the present invention within a scope that does not conflict with each other.

A fuel cell system 100 according to the present invention includes a plurality of stacks 200 connected in series with each other, and it may be operated to supply moisture from one or more stacks of the plurality of stacks 200 to one or more other stacks according to the operation condition of each of the plurality of stacks 200.

The specific operation principle may be to perform supplying moisture from one or more stacks having a relatively superior humidity condition of the plurality of stacks 200 to one or more stacks having a relatively inferior humidity condition to uniformly form a humidity condition between the plurality of stacks.

In this case, when using the flow of air supplied to the plurality of stacks 200, the flow direction of the air flowing into the plurality of stacks 200 is controlled according to the humidity condition of the plurality of stacks 200, so it may operate to supply moisture vapor from one or more stacks having a relatively superior humidity condition of the plurality of stacks 200 to one or more stacks having a relatively inferior humidity condition.

Alternatively, when using the flow of hydrogen supplied to the plurality of stacks 200, the flow direction of hydrogen flowing into the plurality of stacks 200 is controlled according to the humidity condition of the plurality of stacks 200, so it may operate to supply moisture vapor from one or more stacks having a relatively superior humidity condition of the plurality of stacks 200 to one or more stacks having a relatively inferior humidity condition.

Alternatively, in the case of using both the flows of air and hydrogen supplied to the plurality of stacks 200, the flow direction of the air flowing into the plurality of stacks 200 is controlled, and when moisture is supplied from one or more stack of the plurality of stacks 200 to one or more other stacks, the flow direction of hydrogen flowing into the plurality of stacks 200 is controlled, moisture vapor is supplied from one or more the other stacks of the plurality of stacks 200 to one or more stacks, so it may operate to uniformly form the humidity condition of each of the plurality of stacks 200.

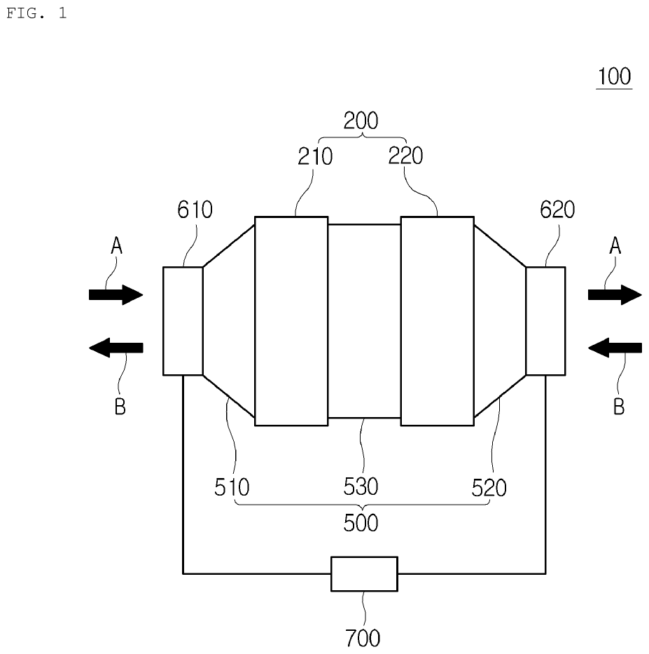

Hereinafter, with reference to FIGS. 1 to 6, a detailed configuration and operation method will be described through embodiments in which the operation principle and technical features of the above-described fuel cell system 100 are implemented.

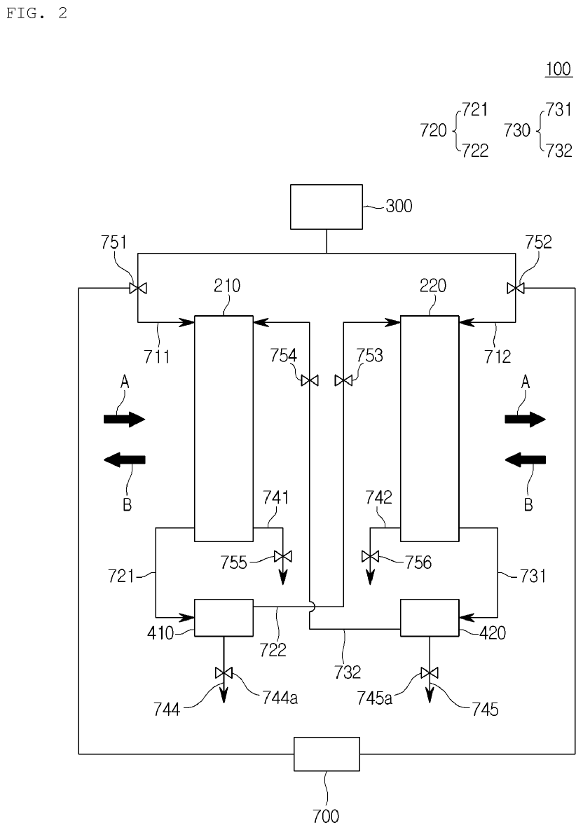

Referring to FIGS. 1 and 2, a first embodiment of the fuel cell system 100 according to the present invention may be configured to include first and second stacks 210, 220, a fuel tank 300, first and second water traps 410, 420, and a duct 500, a blower 600 and a control unit 700.

A first-1 connection fuel pipe 721 and a first-2 connection fuel pipe 722 described below may be a sub-concept of a first connection fuel pipe 720. That is, the first connection fuel pipe 720 may include the first-1 connection fuel pipe 721 connecting the first stack 210 and the first water trap 410, and the first-2 connection fuel pipe 722 connecting the first water trap 410 and the second stack 220. The unreacted hydrogen fuel that has passed through the first stack 210 and the water in a liquid or gaseous state generated in the first stack 210 may flow in the first connection fuel pipe 720.

In addition, a second-1 connection fuel pipe 731 and a second-2 connection fuel pipe 732 may be a sub-concept of a second connection fuel pipe 730. That is, the second connection fuel pipe 730 may include the second-1 connection fuel pipe 731 connecting the second stack 220 and the second water trap 420, and the second-2 connection fuel pipe 732 connecting the second water trap 420 and the first stack 210. The unreacted hydrogen fuel that has passed through the second stack 220 and the water in a liquid or gaseous state generated in the second stack 220 may flow in the second connection fuel pipe 730.

That is, the first connection fuel pipe 720 and the second connection fuel pipe 730 are for guiding the unreacted hydrogen fuel remaining in the stack operated relatively first during forward and reverse direction operations, which will be described later, and the water (in gaseous or liquid sate) generated by the electrochemical reaction of previously operated stack.

The first stack 210 may be a stack for a fuel cell in which a plurality of cells each having an anode provided with hydrogen fuel and a cathode provided with oxygen in the air is stacked. A first ventilation pipe 741 may be connected to a lower portion of the first stack 210 to discharge the unreacted hydrogen fuel containing impurity. A fifth valve 755 may be disposed on the first ventilation pipe 741 to control the external discharge of the impurity inside the stack.

The second stack 220 may be a stack for a fuel cell in which a plurality of cells each having the aforementioned anode and cathode is stacked, and may be disposed adjacent to the first stack 210. A second ventilation pipe 742 may be connected to a lower portion of the second stack 220 to discharge the unreacted hydrogen fuel containing impurity. A sixth valve 756 may be disposed on the second ventilation pipe 742 to control the external discharge of impurity.

When impurity is accumulated in the stack due to a dead end operation and thus performance degradation occurs, the first and second ventilation pipes 741, 742 may be disposed to discharge the impurity to the outside of the stack.

The fuel tank 300 may be a storage tank for storing hydrogen fuel.

The fuel tank 300 and the anode of the first stack 210 may be connected by a first fuel pipe 711, and a first valve 751 may be disposed on the first fuel pipe 711 to control the supply of hydrogen fuel.

The fuel tank 300 and the anode of the second stack 220 may be connected by a second fuel pipe 712, and a second valve 752 may be disposed on the second fuel pipe 712 to control the supply of hydrogen fuel.

Here, the meaning of the connection is a concept including a so-called indirect connection which is a connection via other components, in addition to a direct connection.

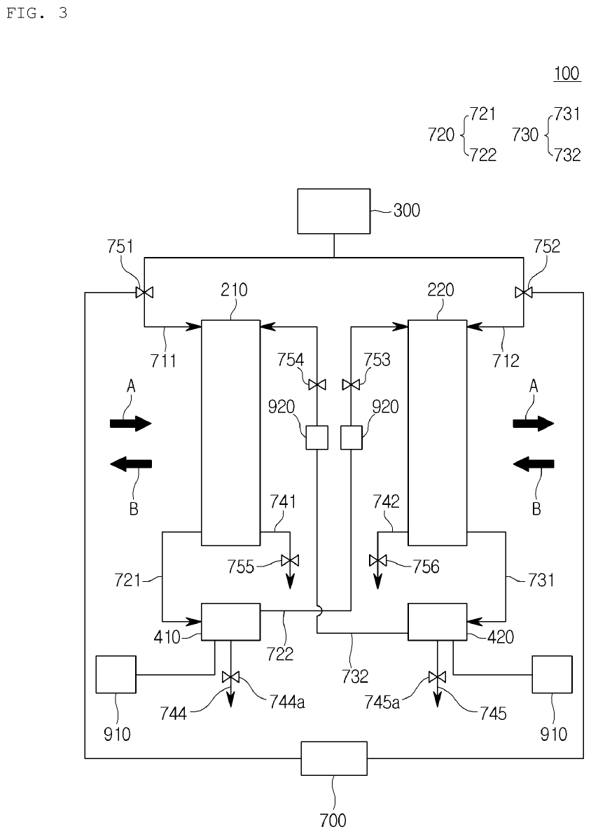

The first water trap 410 may be a storage tank in which liquid water or water vapor is stored. Specifically, the first water trap 410 may store the moisture back-diffused from a cathode (air electrode) to an anode (fuel electrode) in a cell inside the first stack 210, or the condensate condensed from the moisture generated during a circulation process within the stack. In some cases, the water (moisture) in a liquid or gaseous state may be artificially provided to the first water trap 410. This may be implemented by separately connecting a heating device such as a heater 910 illustrated in FIG. 3 to be discussed below, but is not limited thereto.

The first water trap 410 and the lower portion of the first stack 210 may be connected by the first-1 connection fuel pipe 721, and the unreacted hydrogen and liquid water or water vapor may be discharged from the stack 210 to the first water trap 410 through the first-1 connection fuel pipe 721.

In addition, a first discharge pipe 744 may be connected to the first water trap 410, and the water containing impurity may be discharged through the first discharge pipe 744. Whether the first discharge pipe 744 is opened or closed may be controlled by a first discharge valve 744a.

In addition, the first water trap 410 may be connected to the anode of the second stack 220 by the first-2 connection fuel pipe 722 described above. As described above, the unreacted hydrogen fuel remaining in the first stack 210 and water vapor flow in the first-2 connection fuel pipe 722 and then are supplied to the second stack 220. A third valve 753 may be disposed on the first-2 connection fuel pipe 722 to control the supply amount of hydrogen fuel and water vapor.

The second water trap 420 may be a storage tank in which liquid water or water vapor is stored, and the function is the same as that of the first water trap 410.

The second water trap 420 and the lower portion of the second stack 220 may be connected by the second-1 connection fuel pipe 731. Here, the lower portion of the second stack 220 precisely means a discharge part through which the unreacted hydrogen fuel is discharged to the outside of the second stack 220 after the hydrogen fuel supplied from the fuel tank 300 passes through the inside of the second stack 220. The unreacted hydrogen and water in liquid water or water vapor may be discharged from the second stack 220 to the second water trap 420 through the second-1 connection fuel pipe 731.

A second discharge pipe 745 may be connected to the second water trap 420, and the liquid water containing impurity may be discharged through the second discharge pipe 745. Whether the second discharge pipe 745 is opened or closed may be controlled by a second discharge valve 745a.

In addition, the second water trap 420 may be connected to the upper portion of the first stack 210 and the second-2 connection fuel pipe 732. A fourth valve 754 may be disposed on the second-2 connection fuel pipe 732 to control the supply of hydrogen fuel and water vapor.

Here, the aforementioned first to fourth valves 751, 752, 753, 754 may include a solenoid valve capable of partially controlling a supply amount by adjusting the valve opening degree (opening degree). In some cases, the first to fourth valves 751, 752, 753, 754 may be valves that can control only on/off. It is apparent that a variety of valves can be used without limitation of a control of the valve opening degree, shape, and driving source (electricity, hydraulic pressure, pneumatic).

The duct 500 may be formed to sequentially supply air to the first stack 210 and the second stack 220. In addition, the blower 600 may be connected to the duct 500 to supply air to the first and second stacks 210, 220 through the duct 500.

The duct 500 may be configured to include first, second, and third ducts 510, 520, 530, and the blower 600 may be a fan and the like, and in an embodiment of the present invention, may be configured to include a first blowing fan 610 and a second blowing fan 620.

One side of the first duct 510 may be connected to one side of the first stack 210, and the other side of the first duct 510 may be connected to the first blowing fan 610. In this case, the first duct 510 and one side of the first stack 210 may be sealed so that the air introduced through the first blowing fan 610 does not leak.

One side of the second duct 520 may be connected to one side of the second stack 220, and the second blowing fan 620 may be connected to the other side of the second duct 520. In this case, the second duct 520 and one side of the second stack 220 may be sealed so that the air introduced through the second blowing fan 620 does not leak.

The third duct 530 may be disposed between the first stack 210 and the second stack 220, and may seal and connect the first stack 210 and the second stack 220.

In an embodiment of the present invention, a one-way air flow is designated as a forward direction (A), and an opposite air flow is designated as a reverse direction (B). Accordingly, the operation in which air is first supplied to the first stack 210 and then supplied to the second stack 220 may be defined as a forward direction (A) operation, and the operation in which air is first supplied to the second stack 220 and then supplied to the first stack 210 may be defined as a reverse direction (B) operation.

The blower 600 applied to an embodiment of the present invention may change the flow of air in the forward direction (A) and the reverse direction (B). The blower 600 may select the forward direction (A) operation to supply air in the direction from the first stack 210 to the second stack 220. Alternatively, the blower 600 may select the reverse direction (B) operation to supply air in the direction from the second stack 220 to the first stack 210.

In FIG. 1, two blowers 600 are illustrated to be disposed, but this is only an example, and one may be disposed on either side.

In addition, if the blower 600 can artificially form the flow of air in the forward direction (A) or the reverse direction (B), various methods other than the blowing fan method may be employed.

Meanwhile, the control unit 700 can control at least one of the first valve 751, the second valve 752, the third valve 753, the fourth valve 754 and the blower 600 to enable the forward direction (A) operation performing from the first stack 210 to the second stack 220 and the reverse direction (B) operation performing from the second stack 220 to the first stack 210, according to the operation states of the first stack 210 and the second stack 220.

As an example of the operation of the control unit 700, when humidification is required due to a lower humidity of the first stack 210, or when performance degradation of the first stack 210 occurs, the control unit 700 may control the first valve 751 and the second valve 752 to supply hydrogen fuel to the anode of the first stack 210 through the second water trap 420.

Specifically, the control unit 700 closes the first valve 751 and opens the second valve 752 to supply hydrogen fuel from the fuel tank 300 to the second stack 220. Thereafter, the unreacted hydrogen not used inside the second stack 220 is discharged to the second water trap 420. Next, the control unit 700 opens the fourth valve 754 of the second-2 connection fuel pipe 732 to supply the hydrogen fuel to the anode of the first stack 210. Through such valve control, the supply of hydrogen fuel can be controlled. In this case, the third valve 753 of the first-2 connection fuel pipe 722 may be closed. Accordingly, the moisture in a liquid or gaseous state stored in the second water trap 420 may be supplied to the first stack 210 by mixing with the unreacted hydrogen to humidify the first stack 210. As a result, the performance degradation caused by the low humidity of the first stack 210 may be resolved.

As another example of the operation of the control unit 700, the control unit 700 may control the blower 600 to supply the external air to the cathode of the first stack 210 after passing through the cathode of the second stack 220 when humidification is required due to the low humidity of the first stack 210 or when the performance degradation of the first stack 210 occurs.

Specifically, the control unit 700 may control the rotation direction of the blower 600 to switch the flow of air from the forward direction (A) to the reverse direction (B). Accordingly, the air flowing from the first stack 210 to the second stack 220 flows from the second stack 220 to the first stack 210.

The control unit 700 opens the first valve 751 and the third valve 753 and closes the second valve 752 and the fourth valve 754 so that hydrogen fuel is sequentially supplied from the fuel tank 300 to the first stack 210, and from the first stack 210 to the second stack 220 during the forward direction (A) operation. The control unit 700 controls the blower 600 to supply air in the forward direction (A) in the same way as the fuel supply direction. That is, the control unit 700 controls the blower 600 so that the external air is first supplied to the first stack 210 and the air (to be precise, oxygen) that has not reacted in the first stack 210 can be sequentially supplied to the second stack 220.

The control unit 700 controls the first to fourth valves 751, 752, 753, 754 and the blower 600 for the reverse direction (B) operation when the reverse direction (B) operation is required, that is, when the humidity condition of the first stack 210 is low or the performance degradation of the first stack 210 occurs. In detail, during the reverse direction (B) operation, the second valve 752 and the fourth valve 754 are opened and the first valve 751 and the third valve 753 are closed. Accordingly, the hydrogen fuel in the fuel tank 300 is supplied to the first stack 210 via the second stack 220. In this process, the hydrogen fuel supplied to the first stack 210 passes through the second water trap 420 to receive moisture, so that the first stack 210 can be humidified. Accordingly, the problem of performance degradation of the first stack 210 may be resolved.

On the contrary, when the performance degradation of the second stack 220 occurs while continuing the reverse direction (B) operation, the control unit 700 may switch the reverse direction (B) operation to the forward direction (A) operation again. Since the forward direction (A) operation is the same as described above, a redundant description will be omitted. That is, the control unit 700 controls the first to fourth valves 751, 752, 753, 754 and the blower 600 so that the forward direction (A) and reverse direction (B) operations are performed according to the operation states of the first stack 210 and the second stack 220. The operation states (degradation of performance, whether or not humidification is required, etc.) of the first stack 210 and the second stack 220 may be detected by electrically measuring the voltage and current of the stack.

In some cases, the control unit 700 may set the operation time and periodically alternately perform the forward direction (A) operation and the reverse direction (B) operation. That is, whether or not humidification of a specific stack is required may be determined based on whether or not a predetermined time has elapsed, in addition to sensing the voltage/current of a corresponding stack.

When the fuel cell system 100 having a plurality of stacks is operated in the forward direction (A) and the reverse direction (B), fresh hydrogen fuel in the fuel tank 300 may be supplied to each stack, and as the flows of fuel and air in the forward and reverse directions occur in each stack, the impurity contained in the stack can be easily discharged to the outside of the stack. Accordingly, in the case of the conventional dead end method, unused hydrogen fuel must be ventilated to forcibly discharge the impurity accumulated inside the stack to the outside, whereas in the case of this fuel cell system, the need for forced ventilation is significantly reduced. Accordingly, it is possible to maximize the hydrogen fuel utilization rate by minimizing the ventilation process in which unused hydrogen fuel is also discharged to the outside for the purpose of discharging impurity.

In addition, the control unit 700 may control the opening and closing of the fifth and sixth valves 755, 756 of the first and second ventilation pipes 741, 742 to control whether or not the hydrogen fuel containing impurity is discharged, and may control the opening and closing of the first and second discharge pipes 744, 745 of the first and second water traps 410, 420 to control whether or not the liquid water containing impurity is discharged.

In addition, in the fuel cell system 100 illustrated in FIG. 3 to be discussed below, a heater 910 may be controlled to increase water vapor.

Meanwhile, referring to FIG. 3, another form in the first embodiment of the fuel cell system 100 according to the present invention may be configured to further include the heater 910 and a filter 920, in addition to the first and second stacks 210, 220, the fuel tank 300, the first and second water traps 410, 420, the duct 500 and the blower 600.

The heater 910 may be connected to the first and second water traps 410, 420. When the water vapor present in the first and second water traps 410, 420 is not sufficient, so that the water vapor supplied to the first stack 210 or the second stack 220 is insufficient to form a humidity condition, the heater 910 may perform a function of heating and evaporating the liquid water present in the first and second water traps 410, 420 to vaporize it into water vapor. That is, when the water vapor is not enough, the liquid water is exceptionally heated and evaporated to make up for insufficient water vapor.

The filter 920 may be disposed on the first-2 connection fuel pipe 722 connecting the first water trap 410 and the second stack 220 or the second-2 connection fuel pipe 732 connecting the second water trap 420 and the first stack 210. The filter 920 may perform a function of filtering the impurity contained in unreacted hydrogen or water vapor. Through this, the purity of unreacted hydrogen or water vapor supplied to the first and second stacks 210, 220 may be increased, and ultimately, the reaction stability and reaction power of the fuel cell stack may be increased.

The configuration of the first embodiment of the fuel cell system 100 according to the present invention is as described above, and an operation method of the fuel cell system 100 according to the above-described configuration will be described below.

In the following description, an operation method in which air and hydrogen fuel flow in the same direction may be defined as a co-flow operation, and an operation method in which air and hydrogen fuel flow in opposite directions may be defined as a counter-flow operation.

For example, when both air and hydrogen fuel flow in the direction from a first stack to a second stack, or when both air and hydrogen fuel flow in the direction from the second stack to the first stack, both air and hydrogen fuel flow in a co-flow operation mode.

In contrast, when air flows in the direction from the first stack to the second stack, and the hydrogen fuel flows in the direction from the second stack to the first stack, or when air flows in the direction from the second stack to the first stack, and the hydrogen fuel flows in the direction from the first stack to the second stack, the air and the hydrogen fuel flow in a counter-flow operation mode.

Hereinafter, the co-flow operation mode and the counter-flow operation mode will be described in detail for each operation mode.

In one operation mode (co-flow operation mode), when the humidity condition of the second stack 220 is relatively inferior to that of the first stack 210, the humidity environment of the second stack 220 needs to be improved so that the humidity condition between the first stack 210 and the second stack 220 is uniformly formed, the blower 600 may be manipulated to set the flow of air in the forward direction (A).

When the flow of air is set in the forward direction (A) by manipulating the blower 600, the hydrogen fuel is supplied from the fuel tank 300 to the anode of the first stack 210 through the first fuel pipe 711. At this time, the air flowing in the forward direction (A) is supplied to the cathode of the first stack 210. The supply of hydrogen fuel through the first fuel pipe 711 may be controlled by the first valve 751.

The hydrogen fuel and oxygen in the air undergo an electrochemical reaction in the first stack 210, and the generated water is discharged to the first water trap 410 through the first-1 connection fuel pipe 721. In addition, unreacted hydrogen fuel may be discharged to the first water trap 410 through the first-1 connection fuel pipe 721.

The first ventilation pipe 741 is disposed on at the lower portion of the first stack 210, and when unreacted hydrogen fuel contains a large amount of impurity, it may be discharged through the first ventilation pipe 741. The discharge of hydrogen fuel through the first ventilation pipe 741 may be controlled by the fifth valve 755.

The water discharged to the first water trap 410 may be in liquid or gaseous state.

In this case, unreacted hydrogen fuel and water vapor may be supplied from the first water trap 410 to the second stack 220 through the first-2 connection fuel pipe 722. The supply of hydrogen fuel through the first-2 connection fuel pipe 722 may be controlled by the third valve 753.

If the liquid water present in the first water trap 410 contains a large amount of impurity, it may be discharged to the outside through the first discharge pipe 744.

The hydrogen fuel supplied to the second stack 220 flows in the forward direction (A) and undergoes an electrochemical reaction inside the second stack 220 with oxygen in the air that has passed through the first stack 210. At this time, the generated water is discharged to the second water trap 420 through the second-1 connection fuel pipe 731. In addition, unreacted hydrogen fuel may be discharged to the second water trap 420 through the second-1 connection fuel pipe 731.

The second ventilation pipe 742 is disposed on the lower portion of the second stack 220, and when unreacted hydrogen fuel contains a large amount of impurity, it may be discharged through the second ventilation pipe 742. The discharge of hydrogen fuel through the second ventilation pipe 742 may be controlled by a sixth valve 756.

The water discharged to the second water trap 420 may be water in a liquid or gaseous state.

If the liquid water present in the second water trap 420 contains a large amount of impurity, it may be discharged to the outside through the second discharge pipe 745.

In summary, in one operation method, when the humidity environment of the second stack 220 is improved to uniformly form the humidity condition between the first stack 210 and the second stack 220, the blower 600 is set to operate to flow the air in the forward direction (A) and supply the hydrogen fuel to the first stack 210. Accordingly, air and hydrogen fuel are sequentially supplied from the first stack 210 to the second stack 220, and the water vapor generated in the first stack 210 is supplied to the second stack 220, and the humidity environment of the second stack is improved.

On the other hand, in another operation mode (co-flow operation mode), when the humidity condition of the first stack 210 is relatively inferior to that of the second stack 220, the humidity environment of the first stack 210 needs to be improved so that the humidity condition between the first stack 210 and the second stack 220 is uniformly formed, the blower 600 may be manipulated to set the flow air in the reverse direction (B).

When the blower 600 is manipulated to set the flow of air in the reverse direction (B), the hydrogen fuel is supplied from the fuel tank 300 to the anode of the second stack 220 through the second fuel pipe 712. At this time, the air flowing in the reverse direction (B) is supplied to the cathode of the second stack 220. The supply of hydrogen fuel through the second fuel pipe 712 may be controlled by the second valve 752.

The hydrogen fuel and oxygen in the air undergo an electrochemical reaction in the second stack 220, and the generated water is discharged to the second water trap 420 through the second-1 connection fuel pipe 731. In addition, unreacted hydrogen fuel may be discharged to the second water trap 420 through the second-1 connection fuel pipe 731.

The second ventilation pipe 742 is disposed on the lower portion of the second stack 220, and when unreacted hydrogen fuel contains a large amount of impurity, it may be discharged through the second ventilation pipe 742. The discharge of hydrogen fuel through the second ventilation pipe 742 may be controlled by the sixth valve 756.

The water discharged to the second water trap 420 may be water in a liquid or gaseous state.

In this case, unreacted hydrogen fuel and water vapor may be supplied from the second water trap 420 to the first stack 210 through the second-2 connection fuel pipe 732. The supply of hydrogen fuel through the second-2 connection fuel pipe 732 may be controlled by the fourth valve 754.

If the liquid water present in the second water trap 420 contains a large amount of impurity, it may be discharged to the outside through the second discharge pipe 745. The discharge of water through the second discharge pipe 745 may be controlled by the second discharge valve.

The hydrogen fuel supplied to the first stack 210 flows in the reverse direction (B) and undergoes an electrochemical reaction in the first stack 210 with oxygen in the air that has passed through the second stack 220. At this time, the generated water is discharged to the first water trap 410 through the first-1 connection fuel pipe 721. In addition, unreacted hydrogen fuel may be discharged to the first water trap 410 through the first-1 connection fuel pipe 721.

The first ventilation pipe 741 is disposed on the lower portion of the first stack 210, and when unreacted hydrogen fuel contains a large amount of impurity, it may be discharged through the first ventilation pipe 741. The discharge of hydrogen fuel through the first ventilation pipe 741 may be controlled by the fifth valve 755.

The water discharged to the first water trap 410 may be in a liquid or gaseous state.

If the liquid water present in the first water trap 410 contains a large amount of impurity, it may be discharged to the outside through the first discharge pipe 744.

In summary, in another operation method, when the humidity environment of the first stack 210 is improved to uniformly form the humidity condition between the first stack 210 and the second stack 220, the operation of the blower 600 is set to flow air in the reverse direction (B) and supply hydrogen fuel to the second stack 220. Accordingly, air and hydrogen fuel are sequentially supplied from the second stack 220 to the first stack 210, and the water vapor generated in the second stack 220 is supplied to the first stack 210, and the humidity environment of the first stack is improved.

On the other hand, in another operation mode (counter-flow operation mode), by sequentially supplying air and hydrogen fuel to opposite stacks, the first stack 210 and the second stack 220 may operate to maintain the internal moisture balance of each stack by supplying water vapor with each other.

When the blower 600 is manipulated to flow air in the forward direction (A), air is sequentially supplied from the first stack 210 to the second stack 220. At this time, the hydrogen fuel is sequentially supplied from the second stack 220 to the first stack 210. In this case, the first valve 751 is closed, and the second valve 752 is opened.

The electrochemical reaction between oxygen and hydrogen fuel in the air is first performed in the second stack 220, and the water vapor generated in the second stack 220 is discharged to the second water trap 420 and then supplied to the first stack 210 to humidify the first stack 210. In this case, unreacted hydrogen fuel that has not reacted in the second stack 220 is also discharged to the second water trap 420 and then supplied to the first stack 210, and electrochemically reacts with air in the first stack 210.

In addition, the water vapor generated in the first stack 210 is discharged to the first water trap 410 and then supplied to the second stack 220 to humidify the second stack 220.

If the unreacted hydrogen contains a large amount of impurity, the sixth valve 756 controlling the second ventilation pipe 742 is opened to discharge the unreacted hydrogen.

Conversely, when the blower 600 is manufactured to set the flow of air in the reverse direction (B), air is sequentially supplied from the second stack 220 to the first stack 210. At this time, the hydrogen fuel is sequentially supplied from the first stack 210 to the second stack 220. In this case, the second valve 752 is closed, and the first valve 751 is opened.

The electrochemical reaction between oxygen in the air and hydrogen fuel is first performed in the first stack 210, and the water vapor generated in the first stack 210 is discharged to the first water trap 410 and then supplied to the second stack 220 to humidify the second stack 220. In this case, unreacted hydrogen fuel that has not reacted in the first stack 210 is also discharged to the first water trap 410 and then supplied to the second stack 220, and electrochemically reacts with air in the second stack 220.

In addition, the water vapor generated in the second stack 220 is discharged to the second water trap 420 and then supplied to the first stack 210 to humidify the first stack 210.

If the unreacted hydrogen contains a large amount of impurity, the fifth valve 755 controlling the first ventilation pipe 741 is opened to discharge the unreacted hydrogen.

That is, in another operation method, water vapor is supplied between the stacks to uniformly form the humidity conditions for the first and second stacks 210, 220, and at the same time, the hydrogen fuel utilization rate can be maximized.

Hereinafter, a method for controlling the fuel cell system 100 according to the present invention will be described with the structure and operation method of the fuel cell system 100 (the first embodiment) described above.

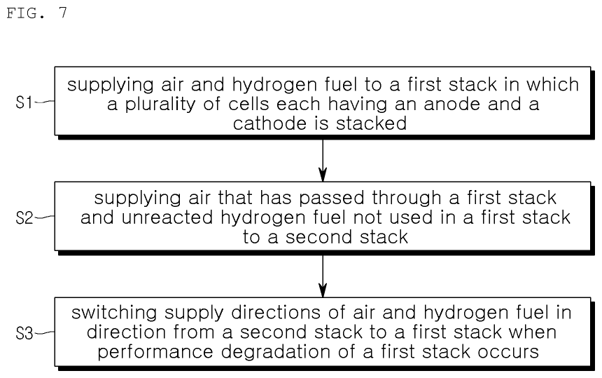

First, with reference to FIG. 7, in the method for controlling the fuel cell system according to the present invention, a co-flow operation direction switching between a plurality of stacks will be described.

As shown in FIG. 7, the method for controlling the fuel cell system 100 according to the present invention may be configured to include the steps of supplying air and hydrogen fuel to the first stack 210 in which a plurality of cells each having an anode and a cathode is stacked (S1), supplying the air that has passed through the first stack 210 and unreacted hydrogen fuel not used in the first stack 210 to the second stack 220 in which a plurality of cells is stacked (S2), and switching the supply directions of the air and the hydrogen fuel in the direction from the second stack 220 to the first stack 210 when the performance degradation of the first stack 210 occurs (S3).

First, in the initial operation, in the step (S1) of supplying air and hydrogen fuel to the first stack 210 in which the plurality of cells having the anode and the cathode is stacked, the blower 600 is manipulated to control the flow of air in the forward direction (A) to supply the air in the direction from the first stack 210 to the second stack 220.

Then, the first valve 751 of the first fuel pipe 711 is opened to supply the hydrogen fuel from the fuel tank 300 to the first stack 210. The supplied air and hydrogen fuel undergo an electrochemical reaction in the first stack 210. At this time, the second valve 752 of the second fuel pipe 712 is in a closed state.

Next, in the step (S2) of supplying the air that has passed through the first stack 210 and unreacted hydrogen fuel not used in the first stack 210 to the second stack 220 in which a plurality of cells is stacked, the air that has passed through the first stack 210 flows in the forward direction (A) and flows into the second stack 220.

Then, as described above, the unreacted hydrogen of the hydrogen fuel supplied to the first stack 210 is discharged to the first water trap 410 through the first-1 connection fuel pipe 721, and is supplied from the first water trap 410 to the second stack 220 through the first-2 connection fuel pipe 722. Thereafter, an electrochemical reaction is performed inside the second stack 220.

The steps (S1 and S2) are continuously performed, and the fuel cell stack generates power.

After a long operation time has elapsed, the performance degradation of the first stack 210 may occur. As one of the causes of such performance degradation, the humidity condition of the first stack 210 may be deteriorated. In this case, the humidity condition of the first stack 210 is relatively inferior to the humidity condition of the second stack 220, so that the output performance may be deteriorated.

In this case, the step (S3) is performed.

Here, the step (S3) of switching the supply directions of the air and the hydrogen fuel in the direction from the second stack 220 to the first stack 210 when the performance degradation of the first stack 210 occurs may be configured to include the steps of supplying the air to the cathode of the first stack 210 via the cathode of the second stack 220 (S3a), supplying the hydrogen of the fuel tank 300 to the anode of the second stack 220 (S3b), and supplying the unreacted hydrogen fuel of the second stack (220) to the anode of the first stack 210 (S3c).

First, in the step (S3a) of supplying the air to the cathode of the first stack 210 via the cathode of the second stack 220, the blower 600 is manipulated to set the flow of air in the reverse direction (B) to supply the air from the second stack 220 to the first stack 210.

Next, in the step (S3b) of supplying the hydrogen fuel of the fuel tank 300 to the anode of the second stack 220, the second valve 752 of the second fuel pipe 712 is opened to supply the hydrogen fuel from the fuel tank 300 to the anode of the second stack 220. The supplied air and hydrogen fuel undergo an electrochemical reaction inside the second stack 220. At this time, the first valve 751 of the first fuel pipe 711 is closed, and the hydrogen fuel is prevented from being supplied from the fuel tank 300 to the first stack 210.

Next, in the step (S3c) of supplying the unreacted hydrogen fuel of the second stack 220 to the anode of the first stack 210, as described above, the unreacted hydrogen fuel of the hydrogen fuel supplied to the second stack 220 is discharged to the second water trap 420 through the second-1 connection fuel pipe 731, and then, supplied from the second water trap 420 to the first stack 210 through the second-2 connection fuel pipe 732. Thereafter, an electrochemical reaction is performed with air inside the first stack 210.

Here, the step (S3c) may include the step of supplying the unreacted hydrogen fuel to the anode of the first stack 210 via the second water trap 420 in which liquid water or water vapor is stored.

Specifically, the water generated in the second stack 220 is discharged to the second water trap 420 through the second-1 connection fuel pipe 731 in a liquid or gaseous state. At this time, the unreacted hydrogen fuel is also discharged to the second water trap 420 in a gaseous state.

In addition, water vapor and unreacted hydrogen fuel are supplied from the second water trap 420 to the first stack 210 through the second-2 connection fuel pipe 732.

The water vapor humidifies the first stack 210 to improve the operation environment of the first stack 210, and the unreacted hydrogen fuel reacts with oxygen in the air again in the first stack 210, so the hydrogen fuel utilization rate is increased.

Here, in particular, since it is a dead-end operation for fuel utilization rate, in the forward direction (A) operation, the unused hydrogen fuel in the first stack 210 is supplied to the anode of the second stack 220 and the hydrogen fuel is also used in the second stack 220, and the unused hydrogen fuel that has not been utilized for the reaction in the second stack 220 is accumulated in the second stack 220.

If it is sensed that the humidity of the first stack 210 is low or that the performance of the first stack 210 is degraded (which can be measured as a voltage), the first valve 751, the second valve 752 and the blower 600 are controlled for the reverse direction (B) operation. In this case, the unused hydrogen fuel accumulated in the second stack 220 is supplied to the first stack 210 while being combined with the fresh hydrogen fuel supplied from the fuel tank 300 through the second fuel pipe 712. As a result, impurity is deposited inside the stack, thereby significantly reducing the need for ventilation.

In other words, there is no need to artificially discharge unused hydrogen fuel to the outside, so that the hydrogen fuel utilization rate can be maximized.

On the contrary, when the step of supplying air and hydrogen fuel to the second stack 220 is first performed, and the performance degradation of the second stack 220 occurs, the step of switching the supply directions of the air and the hydrogen fuel into the direction from the first stack to the second stack 220 may be performed. Since the above-described control method of the fuel cell may be operated in reverse, a corresponding description will be omitted.

On the other hand, the switching condition of the forward direction (A) operation or the reverse direction (B) operation can be set by the humidity state of each stack or the voltage state or operation time of each stack or combination of these conditions. For example, the forward/reverse direction operations may be switched periodically (e.g., in units of 30 minutes, 1 hour, 2 hours, etc.).

Here, whether or not the performance degradation of the stack occurs can be estimated by measuring the humidity, voltage, or operation time of each stack. In particular, in the case of estimating the performance degradation by the operation time, the forward/reverse direction operations of the plurality of stacks are adjusted after a predetermined time elapses, that is, periodically.

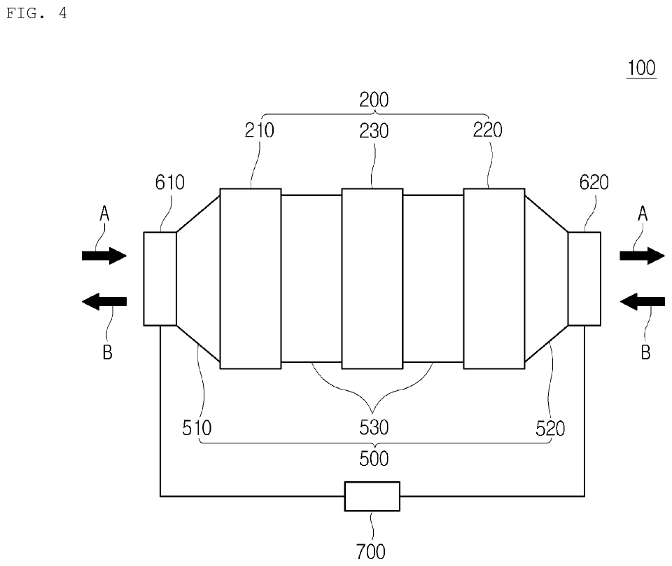

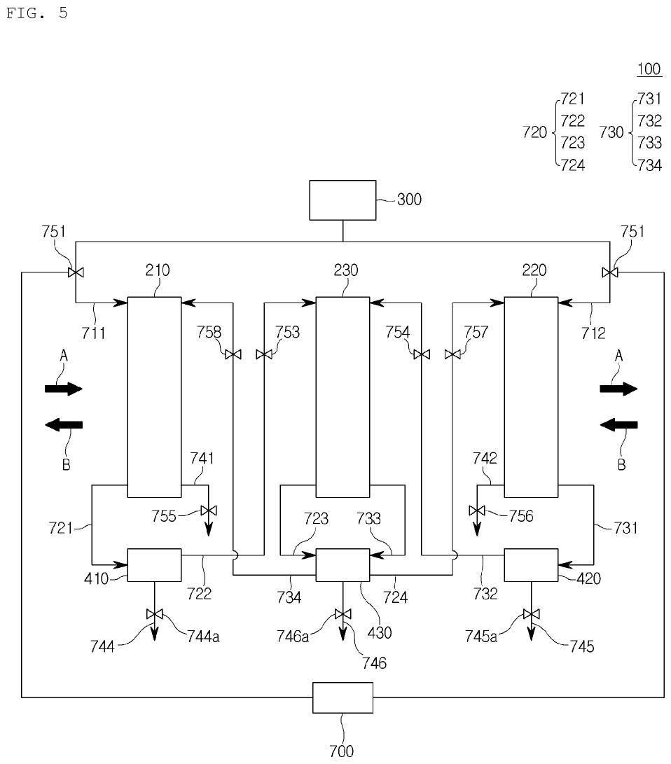

With reference to FIGS. 4 and 5, the second embodiment of the fuel cell system 100 according to the present invention may be configured to include the first, second, and third stacks 210, 220, 230, the fuel tank 300, and the first, second, and third water traps 410, 420, 430, the duct 500 and the blower 600.

The first-1 connection fuel pipe 721, the first-2 connection fuel pipe 722, the first-3 connection fuel pipe 723 and the first-4 connection fuel pipe 724 described below may be a sub-concept of the connection fuel pipe 720, and the second-1 connection fuel pipe 731, the second-2 connection fuel pipe 732, the second-3 connection fuel pipe 733 and the second-4 connection fuel pipe 733 may be a sub-concept of the second connection fuel pipe 730, and the unreacted hydrogen fuel in each stack and the water generated in each stack may flow in the first and second connection fuel pipes 720, 730.

The first stack 210 may be a stack for a fuel cell in which a plurality of cells each having an anode using hydrogen as a fuel and a cathode using oxygen in the air as a fuel is stacked. The first ventilation pipe 741 may be connected to a lower portion of the first stack 210 to discharge unreacted hydrogen fuel containing impurity. The fifth valve 755 may be disposed on the first ventilation pipe 741 to control the discharge of hydrogen fuel.

The second stack 220 may be a stack for a fuel cell in which a plurality of cells each having a fuel electrode and an air electrode is stacked, and may be disposed adjacent to the first stack 210. The second ventilation pipe 742 may be connected to a lower portion of the second stack 220 to discharge the unreacted hydrogen fuel containing impurity. The sixth valve 756 may be disposed on the second ventilation pipe 742 to control the discharge of hydrogen fuel.

The third stack 230 may be a stack for a fuel cell in which a plurality of cells each having an anode and a cathode is stacked, and may be disposed between the first and second stacks 210 and 220.

The fuel tank 300 may be a storage tank for storing hydrogen fuel.

The fuel tank 300 and the anode of the first stack 210 may be connected by the first fuel pipe 711, and the first valve 751 may be disposed on the first fuel pipe 711 to control the supply of hydrogen fuel.

The fuel tank 300 and the anode of the second stack 220 may be connected by the second fuel pipe 712, and the second valve 752 may be disposed on the second fuel pipe 712 to control the supply of hydrogen fuel.

The first water trap 410 may be a storage tank in which liquid water or water vapor is stored. The first water trap 410 and the lower portion of the first stack 210 may be connected by the first-1 connection fuel pipe 721, and unreacted hydrogen and liquid water or water vapor may be discharged from the stack 210 to the first water trap 410 through the first-1 connection fuel pipe 721.

Then, the first discharge pipe 744 may be connected to the first water trap 410, and the liquid water containing impurity may be discharged through the first discharge pipe 744. Whether the first discharge pipe 744 is opened or closed may be controlled by the first discharge valve 744a.

Also, the first water trap 410 may be connected to the upper portion of the third stack 230 by the first-2 connection fuel pipe 722. The third valve 753 may be disposed on the first-2 connection fuel pipe 722 to control the supply of hydrogen fuel and water vapor.

The second water trap 420 may be a storage tank in which water in liquid water or water vapor is stored. The second water trap 420 and the lower portion of the second stack 220 may be connected by the second-1 connection fuel pipe 731, and unreacted hydrogen and liquid water or water vapor may be discharged from the second stack 220 to the second water trap 420 through the second-1 connection fuel pipe 731.

A second discharge pipe 745 may be connected to the second water trap 420, and the liquid water containing impurity may be discharged through the second discharge pipe 745. Whether the second discharge pipe 745 is opened or closed may be controlled by a second discharge valve 745a.

In addition, the second water trap 420 may be connected to the upper portion of the third stack 230 by the second-2 connection fuel pipe 732. The fourth valve 754 may be disposed on the second-2 connection fuel pipe 732 to control the supply of hydrogen fuel and water vapor.

The third water trap 430 may be a storage tank in which water in liquid water or water vapor is stored. The third water trap 430 and the lower portion of the third stack 230 may be connected by the first-3 connection fuel pipe 723 or the second-3 connection fuel pipe 733, and unreacted hydrogen and liquid water or water vapor may be discharged from the third stack 230 to the third water trap 430 through the first-3 connection fuel pipe 733 or the second-3 connection fuel pipe 733.

In addition, the third discharge pipe 746 may be connected to the third water trap 430, and the liquid water containing impurity may be discharged through the third discharge pipe 746. Whether the third discharge pipe 746 is opened or closed may be controlled by the third discharge valve 746a.

In addition, the third water trap 430 may be connected to the upper portion of the second stack 220 by the first-4 connection fuel pipe 724. A seventh valve 757 may be disposed on the first-4 connection fuel pipe 724 to control the supply of hydrogen fuel and water vapor. In addition, the third water trap 430 may be connected to the upper portion of the first stack 210 by the second-4 connection fuel pipe 734. An eighth valve 758 may be disposed on the second-4 connection fuel pipe 734 to control the supply of hydrogen fuel and water vapor.

The duct 500 may be formed to sequentially supply air to the first stack 210 and the second stack 220. In addition, the blower 600 may be connected to the duct 500 to supply air to the first, second, and third stacks 210, 220, 230 through the duct 500.

The duct 500 may be configured to include first, second, and third ducts 510, 520, 530.

One side of the first duct 510 may be connected to one side of the first stack 210, and the blower 600 may be connected to the other side of the first duct 510. In this case, the first duct 510 and one side of the first stack 210 may be sealed so that the air introduced through the blower 600 does not leak.

One side of the second duct 520 may be connected to one side of the second stack 220, and the blower 600 may be connected to the other side of the second duct 520. In this case, the second duct 520 and one side of the second stack 220 may be sealed so that the air introduced through the blower 600 does not leak.

The third duct 530 may be disposed between the first stack 210, the second stack 220, and the third stack 230, and the first stack 210, the second stack 220 and the third stack 230 may be sealed and connected, respectively.

On the other hand, if one-way air flow is determined in the forward direction (A), and the opposite air flow is determined in the reverse direction (B), the operation of switching the flow of air in the forward direction (A) and in the reverse direction (B) may be performed by the blower 600 according to the embodiment of the present invention. The blower 600 may select the forward direction (A) operation to supply air in the direction from the first stack 210 to the second stack 220. Alternatively, the blower 600 may select the reverse direction (B) operation to supply air in the direction from the second stack 220 to the first stack 210

In FIG. 4, the blower 600 is illustrated to be arranged in two, but is not limited thereto, and if the flow of air can be switched in the forward direction (A) or the reverse direction (B), it is also possible to dispose one on either side.

Meanwhile, the control unit 700 may control at least one of the first valve 751, the second valve 752, the third valve 753, the fourth valve 754, the seventh valve 757, the eighth valve 758, and the blower 600 to perform the forward direction (A) operation from the first stack 210 to the second stack 220, and the reverse direction (B) operation from the second stack 220 to the first stack 210 according to the operation states of the first stack 210, the second stack 220 and the third stack 230.

As an example of the operation of the control unit 700, when humidification is required due to a low humidity of the first stack 210, or when performance degradation of the first stack 210 occurs, the control unit 700 may control the first valve 751 and the second valve 752 so that the hydrogen fuel is supplied to the anode of the first stack 210 via the second and third water traps 420, 430.

Specifically, the control unit 700 closes the first valve 751 and opens the second valve 752 to supply hydrogen fuel from the fuel tank 300 to the second stack 220. Thereafter, the unreacted hydrogen not used inside the second stack 220 is discharged to the second water trap 420. Next, the control unit 700 opens the fourth valve 754 of the second-2 connection fuel pipe 732 to supply the hydrogen fuel to the anode of the third stack 230. Thereafter, the third water trap 430 opens the eighth valve 758 of the second-4 connection fuel pipe 734 to supply the hydrogen fuel to the anode of the first stack 210.

Through such valve control, the supply of hydrogen fuel can be controlled. In this case, the third valve 753 of the first-2 connection fuel pipe 722 and the seventh valve 757 of the first-4 connection fuel pipe 724 may be closed.

As another example of the operation of the control unit 700, when humidification is required due to a low humidity of the first stack 210 or when performance degradation of the first stack 210 occurs, the control unit 700 may control the blower 600 so that external air is supplied to the cathode of the first stack 210 after passing through the cathode of the second stack 220.

Specifically, the control unit 700 may control the rotation direction of the blower 600 to change the flow of air from the forward direction (A) to the reverse direction (B). Accordingly, the air flowing from the first stack 210 to the second stack 220 flows from the second stack 220 to the first stack 210.

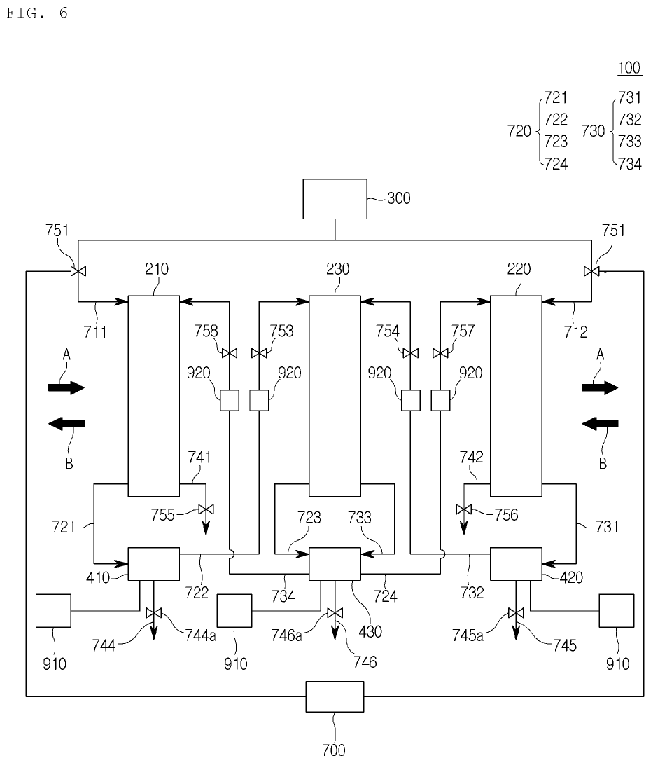

In addition, the control unit 700 may control the fifth and sixth valves 755, 756 of the first and second ventilation pipes 741, 742 in order to control whether or not the hydrogen fuel containing impurity is discharged, and may control the opening and closing of the first, second, and third discharge pipes 744, 745, 746 of the first, second, and third water traps 410, 420, 430 in order to control whether or not the liquid water containing impurity is discharged. In addition, in the fuel cell system 100 illustrated in FIG. 6 to be reviewed below, the heater 910 may be controlled to increase water vapor.

Meanwhile, referring to FIG. 6, another form in the second embodiment of the fuel cell system 100 according to the present invention may be configured to further include a heater 910 and a filter 920, in addition to the first, second, and third stacks 210, 220, 230, the fuel tank 300, and the first, second and third water traps 410, 420, 430, the duct 500 and the blower 600.

The heater 910 may be connected to the first, second and third water traps, respectively. When the water vapor present in the first, second, and third water traps 410, 420, 430 is not sufficient so that the water vapor supplied to each of the first, second, and third stacks 210, 220, 230 is insufficient to form humidity conditions, the heater 910 may perform a function of heating and evaporating the liquid water present in the first, second, and third water traps 410, 420, 430 to vaporize the water vapor. That is, when the water vapor is not enough, the water vapor may be supplemented by exceptionally heating and evaporating the liquid water.

The filter 920 may be disposed on the first-2 connection fuel pipe 722 connecting the first water trap 410 and the third stack 230, the second-2 connection fuel pipe 732 connecting the second water trap 420 and the third stack 230, the second-4 connection fuel pipe 734 connecting the third water trap 430 and the first stack 210, or the first-4 connection fuel pipe 724 connecting the third water trap 430 and the second stack 220.

The filter 920 may perform a function of filtering the impurities that may be contained in unreacted hydrogen or water vapor. Through this, the purity of unreacted hydrogen or water vapor supplied to the first, second, and third stacks 210, 220, 230 may be increased, and ultimately, the reaction stability and reaction power of the fuel cell stack may be increased.

The configuration of the second embodiment of the fuel cell system 100 according to the present invention is the same as above, and an operation method of the fuel cell system 100 according to the above-described configuration will be described below.

For definitions of co-flow and counter-flow, refer to the above description.

Hereinafter, the co-flow operation mode and the counter-flow operation mode for each operation mode will be described in detail.

In one operation mode (co-flow operation mode), when the humidity conditions of the second and third stacks 220, 230 are relatively inferior to that of the first stack 210, the humidity environment of the second and third stacks 220, 230 need to be improved so that the humidity condition between the first stack 210 and the second and third stacks 220, 230 is uniformly formed, the blower 600 may be manipulated to set the flow of air in the forward direction (A).

When the flow of air is set in the forward direction (A) by manipulating the blower 600, the hydrogen fuel is supplied from the fuel tank 300 to the anode of the first stack 210 through the first fuel pipe 711. At this time, the air flowing in the forward direction (A) is supplied to the cathode of the first stack 210. The supply of hydrogen fuel through the first fuel pipe 711 may be controlled by the first valve 751.

The hydrogen fuel and oxygen in the air undergo an electrochemical reaction in the first stack 210, and the generated water is discharged to the first water trap 410 through the first-1 connection fuel pipe 721. In addition, unreacted hydrogen fuel may be discharged to the first water trap 410 through the first-1 connection fuel pipe 721.

The first ventilation pipe 741 is disposed on the lower portion of the first stack 210, and when unreacted hydrogen fuel contains a large amount of impurity, it may be discharged through the first ventilation pipe 741. The discharge of hydrogen fuel through the first ventilation pipe 741 may be controlled by the fifth valve 755.

The water discharged to the first water trap 410 may be in a liquid or gaseous state.

In this case, unreacted hydrogen fuel and water vapor may be supplied from the first water trap 410 to the third stack 230 through the first-2 connection fuel pipe 722. The supply of hydrogen fuel through the first-2 connection fuel pipe 722 may be controlled by the third valve 753.

If the liquid water present in the first water trap 410 contains a large amount of impurity, it may be discharged to the outside through the first discharge pipe 744. The discharge of water through the first discharge pipe 744 may be controlled by the first discharge valve.

The hydrogen fuel supplied to the third stack 230 flows in the forward direction (A) and undergoes in the third stack 230 an electrochemical reaction with the oxygen in the air that has passed through the first stack 210. At this time, the generated water is discharged to the third water trap 430 through the first-3 connection fuel pipe 723. In addition, unreacted hydrogen fuel may be discharged to the third water trap 430 through the first-3 connection fuel pipe 723.

The water discharged to the third water trap 430 may be in a liquid or gaseous state.

At this time, unreacted hydrogen fuel and water vapor may be supplied from the third water trap 430 to the second stack 220 through the first-4 connection fuel pipe 724. The supply of hydrogen fuel through the first-4 connection fuel pipe 724 may be controlled by the seventh valve 757.

If the liquid water present in the third water trap 430 contains a large amount of impurity, it may be discharged to the outside through the third discharge pipe 746.

The unreacted hydrogen fuel supplied to the second stack 220 flows in the forward direction (A), and undergoes an electrochemical reaction in the second stack 220 with the oxygen in the air that has passed through the first and third stacks 210, 230. At this time, the generated water is discharged to the second water trap 420 through the second-1 connection fuel pipe 731. In addition, unreacted hydrogen fuel may be discharged to the second water trap 420 through the second-1 connection fuel pipe 731.

The second ventilation pipe 742 is disposed on the lower portion of the second stack 220, and when unreacted hydrogen fuel contains a large amount of impurity, it may be discharged through the second ventilation pipe 742. The discharge of hydrogen fuel through the second ventilation pipe 742 may be controlled by the sixth valve 756.

If the liquid water present in the second water trap 420 contains a large amount of impurity, it may be discharged to the outside through the second discharge pipe 745.

In summary, in one operation mode, when the humidity environments of the second and third stacks 220, 230 are improved to uniformly form humidity conditions between the first stack 210, the second stack 220, and the third stack 230, the operation of the blower 600 is set to flow air in the forward direction (A), and supply hydrogen fuel to the first stack 210. Accordingly, air and hydrogen fuel are sequentially supplied from the first stack 210 to the second stack 220 through the third stack 230, the water vapor generated in the first stack 210 is supplied to the third stack 230, and the water vapor generated in the third stack 230 is sequentially supplied to the second stack 220 to improve the humidity environments of the second and third stacks 220, 230.

On the other hand, in another operation mode (co-flow operation mode), when the humidity conditions of the first and third stacks 210 and 230 are relatively inferior to that of the second stack 220, the humidity environment of the first and third stacks 210, 230 needs to be improved so that the humidity condition between the second stack 220 and the first and third stacks 210, 230 is uniformly formed, the blower 600 may be manipulated to set the flow of air in the reverse direction (B).

When the blower 600 is manipulated to set the flow of air in the reverse direction (B), the hydrogen fuel is supplied from the fuel tank 300 to the anode of the second stack 220 through the second fuel pipe 712. At this time, air flowing in the reverse direction (B) is supplied to the cathode of the second stack 220. The supply of hydrogen fuel through the second fuel pipe 712 may be controlled by the second valve 752.

In the second stack 220, the hydrogen fuel and oxygen in the air undergo an electrochemical reaction, and the generated water is discharged to the second water trap 420 through the second-1 connection fuel pipe 731. In addition, unreacted hydrogen fuel may be discharged to the second water trap 420 through the second-1 connection fuel pipe 731.

The second ventilation pipe 742 is disposed on the lower portion of the second stack 220, and when unreacted hydrogen fuel contains a large amount of impurity, it may be discharged through the second ventilation pipe 742. The discharge of hydrogen fuel through the second ventilation pipe 742 may be controlled by the sixth valve 756.

The water discharged to the second water trap 420 may be in a liquid or gaseous state.

In this case, unreacted hydrogen fuel and water vapor may be supplied from the second water trap 420 to the third stack 230 through the second-2 connection fuel pipe 732. The supply of hydrogen fuel through the second-2 connection fuel pipe 732 may be controlled by the fourth valve 754.

If the liquid water present in the second water trap 420 contains a large amount of impurity, it may be discharged to the outside through the second discharge pipe 745.

The hydrogen fuel supplied to the third stack 230 flows in the reverse direction (B), and undergoes an electrochemical reaction in the third stack 230 with the oxygen in the air that has passed through the second stack 220. At this time, the generated water is discharged to the third water trap 430 through the 2-3 connection fuel pipe 733. In addition, unreacted hydrogen fuel may be discharged to the third water trap 430 through the second-3 connection fuel pipe 733.

The water discharged to the third water trap 430 may be in a liquid or gaseous state.

In this case, unreacted hydrogen fuel and water vapor may be supplied from the third water trap 430 to the first stack 210 through the second-4 connection fuel pipe 734. The supply of hydrogen fuel through the second-4 connection fuel pipe 734 may be controlled by the eighth valve 758.

If the liquid water present in the third water trap 430 contains a large amount of impurity, it may be discharged to the outside through the third discharge pipe 746.

The unreacted hydrogen fuel supplied to the first stack 210 flows in the reverse direction (B) and undergoes an electrochemical reaction occurs inside the first stack 210 with the oxygen in the air that has passed through the second and third stacks 220, 230. At this time, the generated water is discharged to the first water trap 410 through the first-1 connection fuel pipe 721. In addition, unreacted hydrogen fuel may be discharged to the first water trap 410 through the first-1 connection fuel pipe 721.

The first ventilation pipe 741 is disposed on the lower portion of the first stack 210, and when unreacted hydrogen fuel contains a large amount of impurity, it may be discharged through the first ventilation pipe 741. The discharge of hydrogen fuel through the first ventilation pipe 741 may be controlled by the fifth valve 755.

If the liquid water present in the first water trap 410 contains a large amount of impurity, it may be discharged to the outside through the first discharge pipe 744.

In summary, in another operation mode, when the humidity environments of the first and third stacks 220, 230 are improved to uniformly form humidity conditions between the first stack 210, the second stack 220, and the third stack 230, the operation of the blower 600 is set to flow air in the reverse direction (B), and supply the hydrogen fuel to the second stack 220. Accordingly, air and hydrogen fuel are sequentially supplied from the second stack 220 to the first stack 210 through the third stack 230, and the water vapor generated in the second stack 220 is supplied to the third stack 230, and the water vapor generated in the third stack 230 is sequentially supplied to the first stack 210, so the humidity environments of the first and third stacks 220, 230 are improved.

On the other hand, in another operation mode (counter-flow operation mode), by sequentially supplying air and hydrogen fuel to opposite stacks, the first stack 210, the second stack 220, and the third stack 230 may operate to supply water vapor to each other to maintain the internal moisture balance of each stack.

When the flow of air is set in the forward direction (A) by manipulating the blower 600, air is sequentially supplied from the first stack 210 to the second stack 220 through the third stack 230. At this time, the hydrogen fuel is sequentially supplied from the second stack 220 to the first stack 210 through the third stack 230. In this case, the first valve 751 is closed, and the second valve 752 is opened.

The electrochemical reaction between oxygen in the air and hydrogen fuel is first performed in the second stack 220, and the water vapor generated in the second stack 220 is discharged to the second water trap 420 and then supplied to the third stack 230 to humidify the third stack 230. In this case, unreacted hydrogen fuel that has not reacted in the second stack 220 is also discharged to the second water trap 420 and then supplied to the third stack 230, and electrochemically reacts with air in the third stack 230.

In addition, the water vapor generated in the third stack 230 is discharged to the third water trap 430 and then supplied to the first stack 210 to humidify the first stack 210.

Thereafter, the water vapor generated in the first stack 210 is discharged to the first water trap 410, and then supplied to the third stack 230 to humidify the third stack 230. In this case, the unreacted hydrogen fuel that has not reacted in the first stack 210 is also discharged to the first water trap 410 and then supplied to the third stack 230, and electrochemically reacts with air in the third stack 230.

Then, the water vapor generated in the third stack 230 is discharged to the third water trap 430 and then supplied to the second stack 220 to humidify the second stack 220.

If the unreacted hydrogen contains a large amount of impurity, the sixth valve 756 controlling the second ventilation pipe 742 is opened to discharge the unreacted hydrogen.

Conversely, when the flow of air is set in the reverse direction (B) by manipulating the blower 600, the air sequentially passes from the second stack 220 to the first stack 210 through the third stack 230. At this time, the hydrogen fuel is sequentially supplied from the first stack 210 to the second stack 220 through the third stack 230. In this case, the second valve 752 is closed, and the first valve 751 is opened.

The electrochemical reaction of oxygen in the air and hydrogen fuel is first performed in the first stack 210, and the water vapor generated in the first stack 210 is discharged to the first water trap 410 and then supplied to the third stack 230 to humidify the third stack 230. In this case, the unreacted hydrogen fuel that has not reacted in the first stack 210 is also discharged to the first water trap 410 and then supplied to the third stack 230, and electrochemically reacts with air in the third stack 230.

In addition, the water vapor generated in the third stack 230 is discharged to the third water trap 430 and then supplied to the second stack 220 to humidify the second stack 220.

Thereafter, the water vapor generated in the second stack 220 is discharged to the second water trap 420 and then supplied to the third stack 230 to humidify the third stack 230. In this case, the unreacted hydrogen fuel that has not reacted in the second stack 220 is also discharged to the second water trap 420 and then supplied to the third stack 230, and electrochemically reacts with air in the third stack 230.

Then, the water vapor generated in the third stack 230 is discharged to the third water trap 430 and then supplied to the first stack 210 to humidify the first stack 210.

If the unreacted hydrogen contains a large amount of impurity, the fifth valve 755 controlling the first ventilation pipe 741 is opened to discharge the unreacted hydrogen.

That is, in another operation mode, water vapor is supplied to each other of the stacks to uniformly form the humidity conditions of the first, second, and third stacks 210, 220, 230, and at the same time, hydrogen is circulated in the first, second, and third stacks 210, 220, 230 to maximally increase a hydrogen fuel utilization rate.

Hereinafter, a method for controlling the fuel cell system 100 according to the present invention will be described with the structure and operation mode of the fuel cell system 100 (the second embodiment) described above. The block diagram shown in FIG. 7 can be equally applied to the control method for the second embodiment of the fuel cell system. That is, in a state in which the third stack 230 is disposed between the first and second stacks 210 and 220, a co-flow operation direction switching between the first and second stacks may be applied by the same control method.

The method for controlling the fuel cell system 100 according to the present invention may be configured to include the steps of supplying air and hydrogen fuel to the first stack 210 (S1), supplying the air that has passed through the first stack 210 and unreacted hydrogen fuel not used in the first stack 210 to the second stack 220 through the third stack 230 (S2), and switching the supply direction of the air and the hydrogen fuel in the direction from the second stack 220 to the first stack 210 when the performance degradation of the first stack 210 occurs (S3).

First, in the initial operation, in the step of supplying air and hydrogen fuel to the first stack 210 (S1), the flow of air is controlled in the forward direction (A) by manipulating the blower 600 so that the air is supplied from the first stack 210 to the second stack 220 through the third stack 230.

Then, the first valve 751 of the first fuel pipe 711 is opened to supply hydrogen fuel from the fuel tank 300 to the first stack 210. The supplied air and hydrogen fuel undergo an electrochemical reaction in the first stack 210. At this time, the second valve 752 of the second fuel pipe 712 is in a closed state.

Next, in the step (S2) of supplying the air that has passed through the first stack 210 and unreacted hydrogen fuel not used in the first stack 210 to the second stack 220 through the third stack 230, the air that has passed through the first stack 210 flows in the forward direction (A) and flows into the second stack 220 through the third stack 230.

As described above, among the hydrogen fuel supplied to the first stack 210, unreacted hydrogen is discharged to the first water trap 410 through the first-1 connection fuel pipe 721, and then, it is supplied from the first water trap 410 to the third stack 230 through the first-2 connection fuel pipe 722. Thereafter, an electrochemical reaction is performed in the third stack 230.

Then, as described above, unreacted hydrogen of the hydrogen fuel supplied to the third stack 230 is discharged to the third water trap 430 through the first-3 connection fuel pipe 723, and it is supplied from the third water trap 430 to the second stack 220 through the first-4 connection fuel pipe 724. Thereafter, an electrochemical reaction is performed in the second stack 220.

The steps (S1 and S2) are continuously performed, and the fuel cell stack generates power.

After a long operation time has elapsed, performance degradation of the first stack 210 may occur. As one of the causes of such performance degradation, the humidity condition of the first stack 210 may be deteriorated. In this case, the humidity condition of the first stack 210 is relatively inferior to the humidity condition of the second and third stacks 220, 230, so that the output performance may be degraded.

In this case, the step (S3) is performed.

Here, the step (S3) of switching the supply direction of the air and the hydrogen fuel in the direction from the second stack 220 to the first stack 210 when the performance degradation of the first stack 210 occurs may be configured to include the steps of supplying the air to the cathode of the first stack 210 through the cathode of the third stack 230 through the cathode of the second stack 220 (S3a), supplying the hydrogen fuel of the fuel tank 300 to the anode of the second stack 220 (S3b), and supplying the unreacted hydrogen fuel of the second stack 220 to the anode of the first stack 210 through the anode of the third stack 230 (S3c).

First, in the step (S3a) of supplying the air to the cathode of the first stack 210 through the cathode of the third stack 230 through the cathode of the second stack 220, the flow of air is controlled in the reverse direction (B) by manipulating the blower 600 so that the air is supplied from the second stack 220 to the first stack 210.

Next, in the step (S3b) of supplying the unreacted hydrogen fuel of the second stack 220 to the anode of the first stack 210, the second valve 752 of the second fuel pipe 712 is opened to supply the hydrogen fuel from the fuel tank 300 to the anode of the second stack 220. The supplied air and hydrogen fuel undergo an electrochemical reaction in the second stack 220. At this time, the first valve 751 of the first fuel pipe 711 is closed to prevent the hydrogen fuel from being supplied from the fuel tank 300 to the first stack 210.

Next, in the step (S3c) of supplying the unreacted hydrogen fuel of the second stack 220 to the anode of the first stack 210 through the anode of the third stack 230, unreacted hydrogen of the hydrogen fuel supplied to the second stack 220 is discharged to the second water trap 420 through the second-1 connection fuel pipe 731, as described above, and it is discharged from the second water trap 420 to the third stack 230 through the second-2 connection fuel pipe 732. Thereafter, in the third stack 230, the hydrogen fuel electrochemically reacts with air.

As described above, unreacted hydrogen of the hydrogen fuel supplied to the third stack 230 is discharged to the third water trap 430 through the second-3 connection fuel pipe 733, and it is supplied from the third water trap 430 to the first stack 210 through the second-4 connection fuel pipe 734. Thereafter, the hydrogen fuel undergoes an electrochemical reaction in the first stack 210.

Here, the step (S3c) may include the step of supplying the unreacted hydrogen fuel to the anode of the first stack 210 through the third water trap 430 in which liquid water or water vapor is stored.

Specifically, the water generated in the third stack 230 is discharged to the third water trap 430 through the second-3 connection fuel pipe 733 in a liquid or gaseous state. At this time, the unreacted hydrogen fuel is also discharged to the third water trap 430 in a gaseous state.

In addition, water vapor and unreacted hydrogen fuel are supplied from the third water trap 430 to the first stack 210 through the second-4 connection fuel pipe 734.

The water vapor humidifies the first stack 210 to improve the operation environment of the first stack 210, and unreacted hydrogen fuel reacts with the oxygen in air again in the first stack 210, so the hydrogen fuel utilization rate is increased.

Here, in particular, since it is a dead-end operation for fuel utilization rate, unused hydrogen fuel in the first stack 210 is supplied to the anode of the second stack 220 during the forward direction (A) operation. Thus, hydrogen fuel is also used in the second stack 220, and unused hydrogen fuel that has not been utilized for the reaction in the second stack 220 is accumulated in the second stack 220.

If it is sensed that the humidity of the first stack 210 is low or that the performance of the first stack 210 is degraded (which can be measured as a voltage), the first valve 751, the second valve 752 and the blower 600 are controlled for the reverse direction (B) operation. In this case, the unused hydrogen fuel accumulated in the second stack 220 is supplied to the first stack 210 while being combined with the fresh hydrogen fuel supplied from the fuel tank 300 through the second fuel pipe 712. As a result, impurities are deposited inside the stack, thereby significantly reducing the need for ventilation.

In other words, there is no need to artificially discharge unused hydrogen fuel to the outside, so that the hydrogen fuel utilization rate can be maximized.

On the contrary, first, the step of supplying air and hydrogen fuel to the second stack 220 is performed, and when performance degradation of the second stack 220 occurs, the step of switching the supply direction of the air and the hydrogen fuel in the direction from the first stack 210 to the second stack 220 may be performed. Since the above-described method for controlling the fuel cell may be operated in reverse, a corresponding description will be omitted.

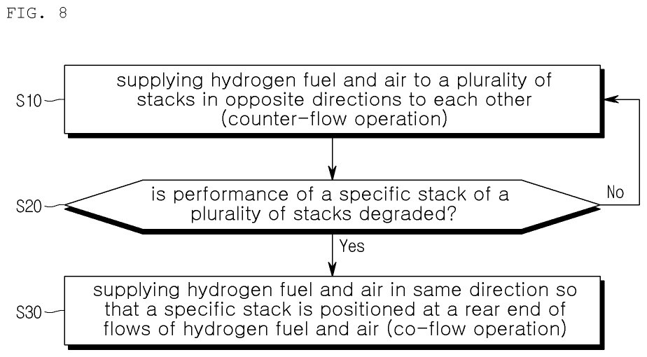

Hereinafter, with reference to FIG. 8, in the method for controlling the fuel cell system 100 according to the present invention, a direction switching from a counter-flow operation to a co-flow operation between a plurality of stacks will be described.

With reference to FIG. 8, the method for controlling the fuel cell system 100 according to the present invention may be configured to include the steps of supplying hydrogen fuel and air to a plurality of stacks in opposite directions to each other (S10), determining whether or not the performance of a specific stack of the plurality of stacks is degraded (S20), and supplying the hydrogen fuel and the air to the plurality of stacks in the same direction so that the specific stack is positioned at the rear end of the flow of hydrogen fuel and the air when the performance degradation of a specific stack occurs (S30).

Here, the step (S10) may be a counter-flow operation, and the step (S30) may be a co-flow operation.

First, in the initial operation, in the step of supplying hydrogen fuel and air to a plurality of stacks in opposite directions to each other (S10) may be the step of maintaining the internal moisture balance of each stack by sequentially supplying air and hydrogen fuel to the stacks opposite to each other so that water vapor is supplied between the plurality of stacks. This may be a technical feature of the counter-flow operation mode.

With reference to FIGS. 1 and 2, the brief description of the control method of the first to fourth valves 751, 752, 753, 754, and the blower 600 during the counter-flow operation in the fuel cell system 100 of the first embodiment having two stacks is provided as follows.

First, when the flow of air is driven in the forward direction (A), that is, in the direction from the first stack 210 to the second stack 220, the control unit 700 controls the first blowing fan 610 and/or second blowing fan 620 of the blower 620 to generate the flow of air in the forward direction (A).

At this time, the control unit 700 controls the first to fourth valves 751, 752, 753, 754 such that the flow of hydrogen fuel is directed from the second stack 220 to the first stack 210. That is, the control unit 700 turns on (or opens) the second valve 752 and the fourth valve 754 and turns off (or closes) the first valve 751 and the third valve 753.

Here, in the case where the flow of air is in the reverse direction (B), since the flow of hydrogen fuel must be in the direction from the first stack 210 to the second stack 220 for a counter-flow operation, the control unit 700 controls the blower 600 and the first to fourth valves 751, 752, 753, 754 accordingly. That is, the first valve 751 and the third valve 753 are turned on (or opened) and the second valve 752 and the fourth valve 754 are turned off (or closed) so that the flow of hydrogen fuel can become from the first stack 210 to the second stack 220.

The above-described counter-flow operation mode is also applicable to the second embodiment of the fuel cell system 100 described above, and a detailed description thereof will be omitted because it is duplicated.

In addition, since the co-flow operation has been described in detail with respect to the operation of the fuel cell system 100 according to the first and second embodiments, a redundant description will be omitted.

Next, the step (S20) of determining whether or not the performance of a specific stack of the plurality of stacks is degraded may include the step of detecting the corresponding specific stack when the output of the specific stack of the plurality of stacks is significantly lower compared to the output of the remaining stacks during the counter-flow operation.

Whether or not the performance of the specific stack is degraded can be measured by sensing the voltage/current of each stack, and the method of detecting the specific stack with degraded performance can be implemented in various ways other than the voltage/current sensing described above. In some cases, whether or not the performance of the specific stack is degraded may be determined based on the operation time without sensing. For example, when the counter-flow operation is performed for a predetermined time (e.g., 30 minutes) or more, the elapse of the predetermined time may be determined as the performance degradation of a specific stack. Accordingly, the operation direction may be switched so that the co-flow operation is performed after a predetermined time has elapsed. That is, the co-flow operation and the counter-flow operation may be alternately performed at a predetermined time period.

A method of designating an output error tolerance range as the relative performance condition between the plurality of stacks, and detecting a specific stack indicating inferior output by deviating from the output error tolerance range may be applied. However, the present invention is not necessarily limited thereto.

There may be various causes for a decrease in an output of a stack, but in the present invention, a case in which the output is decreased as the humidity condition of a specific stack is significantly deteriorated may be exemplified. That is, it may be a case in which the humidity condition of a specific stack is relatively inferior to the humidity conditions of the rest stacks, and as a result, the output performance degradation that deviates from a preset output error tolerance range occurs.

As a result of the performance measurement, if all of the plurality of stacks are within the output error tolerance range of the relative performance condition (NO), the counter-flow operation is continuously maintained.

Conversely, if the performance of a specific stack of the plurality of stacks is out of an allowable output error tolerance range to indicate a performance degradation state (YES), the step (S30) is executed.

Next, the step (S30) of supplying hydrogen fuel and air to the plurality of stacks in the same direction so that the specific stack is positioned at the rear end of the flow of hydrogen fuel and air may be the step of improving the humidity condition of the specific stack positioned at the rear end of the flow of air and hydrogen fuel by supplying the air and the hydrogen fuel to the plurality of stacks in the same direction.

That is, it is switched from the counter-flow operation in which water vapor is supplied to each stack to maintain the internal moisture balance of each stack, to the co-flow operation in which water vapor is supplied to a specific stack to increase the internal moisture of the specific stack.

In the present invention, since the cause of performance degradation of a specific stack is set to a relative humidity condition inferior to that of the specific stack, the switching of the operation method may be operated for the purpose of improving the humidity condition of the specific stack.

For a detailed description of the co-flow operation mode, refer to the description of the first and second embodiments of the fuel cell system 100 described above.

The above is merely a specific example of a fuel cell system and a control method thereof.

Therefore, those of ordinary skilled in the art will be able to easily grasp that the present invention can be substituted and modified in various forms without departing from the spirit of the present invention as set forth in the claims below.

DESCRIPTION OF REFERENCE NUMERALS

| | |
|---|---|
| 100: fuel cell system | |
| 200: stack | 210: first stack |
| 220: second stack | 230: third stack |
| 300: fuel tank | 410: first water trap |
| 420: second water trap | 430: third water trap |
| 500: duct | 510: first duct |
| 520: second duct | 530: third duct |
| 600: blower | 610: first blowing fan |
| 620: second blowing fan | 700: control unit |
| 711: first fuel pipe | 712: second fuel pipe |
| 720: first connection fuel pipe | |
| 721: first-1 connection fuel pipe | |
| 722: first-2 connection fuel pipe | |
| 723: first-3 connection fuel pipe | |
| 724: first-4 connection fuel pipe | |
| 730: second connection fuel pipe | |
| 731: second-1 connection fuel pipe | |
| 732: second-2 connection fuel pipe | |
| 733: second-3 connection fuel pipe | |
| 734: second-4 connection fuel pipe | |
| 741: first ventilation pipe | |
| 742: second ventilation pipe | |
| 744: first discharge pipe | 745: second discharge pipe |
| 746: third discharge pipe | 751: first valve |
| 752: second valve | 753: third valve |
| 754: fourth valve | 755: fifth valve |
| 756: sixth valve | 757: seventh valve |
| 758: eight valve | |
| 910: heater | 920: filter |

What is claimed is:

1. A fuel cell system comprising:
a plurality of stacks connected in series with each other,
wherein moisture is supplied from one or more stacks of the plurality of stacks to one or more other stacks according to an operation condition of each of the plurality of stacks.

2. The fuel cell system according to claim 1, wherein the moisture is supplied from one or more stacks having a relatively superior humidity condition of the plurality of stacks to one or more stacks having a relatively inferior humidity condition to uniformly form a humidity condition between the plurality of stacks.

3. The fuel cell system according to claim 2, wherein by controlling a flow direction of air flowing into the plurality of stacks according to the humidity condition of the plurality of stacks, water vapor is supplied from the one or more stacks having a relatively superior humidity condition of the plurality of stacks to the one or more stacks having a relatively inferior humidity condition.

4. The fuel cell system according to claim 2, wherein by controlling a flow direction of hydrogen flowing into the plurality of stacks according to the humidity condition of the plurality of stacks, water vapor is supplied from the one or more stacks having a relatively superior humidity condition of the plurality of stack to the one or more stacks having a relatively inferior humidity condition.

5. The fuel cell system according to claim 2, wherein when the moisture is supplied from the one or more stacks of the plurality of stacks to the one or more other stacks by controlling a flow direction of air flowing into the plurality of stacks, water vapor is supplied from the one or more other stacks of the plurality of stacks to the one or more stacks by controlling a flow direction of hydrogen flowing into the plurality of stacks so that the humidity condition of each of the plurality of stacks is uniformly formed.

6. A fuel cell system comprising:
a fuel tank which stores hydrogen fuel;
a first stack in which a plurality of cells each having an anode and a cathode is stacked;
a second stack in which the plurality of cells each having the anode and the cathode is stacked and which is disposed adjacent to the first stack;
a duct which is formed to sequentially supply air to the first stack and the second stack;
a blower which supplies the air to the first and second stacks through the duct;
a first water trap in which liquid water or water vapor is stored;
a first fuel pipe which connects the fuel tank and the anode of the first stack; and
a first connection fuel pipe which connects the anode of the first stack and the anode of the second stack through the first water trap.

7. The fuel cell system according to claim 6, wherein the duct is configured to seal the first stack and the second stack so that the air supplied by the blower does not leak to an outside of the first stack and the second stack.

8. The fuel cell system according to claim 6, further comprising:
a second fuel pipe which connects the fuel tank and the anode of the second stack;
a second water trap in which the water in a liquid or gaseous state is stored; and
a second connection fuel pipe which connects the anode of the second stack and the anode of the first stack through the second water trap.

9. The fuel cell system according to claim 8, further comprising:
a first valve which is installed in the first fuel pipe;
a second valve which is installed in the second fuel pipe; and
a control unit which controls at least one of the first valve, the second valve and the blower to enable a forward direction operation from the first stack to the second stack and a reverse direction operation from the second stack to the first stack according to operation states of the first stack and the second stack.

10. The fuel cell system according to claim 9, further comprising the control unit which controls the first valve and the second valve so that the hydrogen fuel is supplied to the anode of the first stack through the second water trap when humidification is required due to low humidity of the first stack or when performance degradation of the first stack occurs.

11. The fuel cell system according to claim 10, wherein when the humidification is required due to the low humidity of the first stack, or when the performance degradation of the first stack occurs, the control unit controls the blower to supply an external air to the cathode of the first stack after passing through the cathode of the second stack.

12. The fuel cell system according to claim 6, further comprising:
a second fuel pipe which connects the fuel tank and the anode of the second stack; and
a control unit which controls a first valve and the blower to supply the hydrogen fuel and the air to the second stack after passing through the first stack when humidification is required due to low humidity of the second stack or when performance degradation of the second stack occurs.

13. The fuel cell system according to claim 6, further comprising:
a first valve which is installed in the first fuel pipe;
a second fuel pipe which connects the fuel tank and the anode of the second stack; and
a second valve which is installed in the second fuel pipe;
a control unit which controls at least one of the first valve, the second valve and the blower to enable a forward direction operation from the first stack to the second stack and a reverse direction operation from the second stack to the first stack according to operating states of the first stack and the second stack.

14. The fuel cell system according to claim 13, further comprising a third stack which is disposed between the first stack and the second stack,
wherein the duct is configured to seal the first to third stacks.

15. The fuel cell system according to claim 6, further comprising:
a first valve which is installed in the first fuel pipe;
a second fuel pipe which connects the fuel tank and the anode of the second stack;
a second valve which is installed in the second fuel pipe; and
a control unit which controls at least one of the first valve, the second valve and the blower so that a flow of the hydrogen fuel and a flow of the air supplied to the first stack and the second stack are in opposite directions or in the same direction according to operation states of the first stack and the second stack.

16. A method for controlling a fuel cell system comprising the steps of:
supplying air and hydrogen fuel to a first stack in which a plurality of cells each having an anode and a cathode is stacked;
supplying the air passing through the first stack and unreacted hydrogen fuel not used in the first stack to a second stack in which the plurality of cells is stacked; and
switching a supply direction of the air and the hydrogen fuel in a direction from the second stack to the first stack when performance degradation of the first stack occurs.

17. The method for controlling a fuel cell system according to claim 16, wherein the step of switching a supply direction of the air and the hydrogen fuel in a direction from the second stack to the first stack includes the steps of:
supplying the air to the cathode of the first stack through a cathode of the second stack;
supplying the hydrogen fuel of a fuel tank to an anode of the second stack; and
supplying the unreacted hydrogen fuel of the second stack to the anode of the first stack.

18. The method for controlling a fuel cell system according to claim 17, wherein the step of supplying the unreacted hydrogen fuel of the second stack to the anode of the first stack includes the step of supplying the unreacted hydrogen fuel to the anode of the first stack through a water trap in which water in a liquid or gaseous state is stored.

19. A method for controlling a fuel cell system including a plurality of cells, comprising:
supplying hydrogen fuel and air to the plurality of stacks so that supply directions of the hydrogen fuel and the air to the plurality of stacks are opposite to each other; and
supplying the hydrogen fuel and the air to the plurality of stacks in the same direction so that a specific stack is positioned at a rear end of the flows of the hydrogen fuel and the air when performance degradation of the specific stack of the plurality of stacks occurs.
